(19) United States
(12) Patent Application Publication
(10) Pub. No.: US 2022/0290872 A1
(43) Pub. Date: Sep. 15, 2022

(54) COOKING-APPLIANCE SYSTEM

(71) Applicant: BSH Hausgeräte GmbH, Munich (DE)

(72) Inventors: Laetitia Angelo, Schiltigheim (FR); Aurélien Chartrel, Lingolsheim (FR); Laura Fanlo Egea, Zaragoza (ES); Lukas Fischer, Rosenheim (DE); Jose Eduardo Galve Villa, Zaragoza (ES); Guillaume Laurent, Bischoffsheim (FR); Demetrio Torrubia Marco, Zaragoza (ES); Alexander Wagner, Trostberg (DE)

(21) Appl. No.: 17/635,393

(22) PCT Filed: Aug. 25, 2020
(86) PCT No.: PCT/EP2020/073698

§ 371 Date: Feb. 15, 2022

(30) Foreign Application Priority Data
Sep. 6, 2019 (EP) 19382769.8

(51) Int. Cl. F24C 15/20

(52) U.S. Cl. CPC F24C 15/2042; H05B 6/12

(57) ABSTRACT

A cooking-appliance system includes a cooktop having a cooktop panel with an extractor aperture for suction extraction of vapors which are produced in an operating state. An extractor unit is provided for suction extraction of the vapors through the extractor aperture; and an oven is arranged beneath the cooktop in an installation position.

The invention relates to a cooking-appliance system as claimed in the preamble of claim 1 and a method for mounting a cooking-appliance system as claimed in the preamble of claim 13.

A cooking-appliance system which is configured as an induction-cooking-appliance system, which has a cooktop and an oven, is already known from the prior art. The cooktop has a cooktop panel with an extractor aperture for suction extraction of vapors which are produced in an operating state. An extractor unit of the cooktop, which in an operating state suctions the vapors through the extractor aperture, is arranged beneath the cooktop panel. The oven is arranged so as to be spatially separated from the cooktop. A region beneath the cooktop is free of the oven so as to avoid thereby interference between the oven and the extractor unit, and since the region beneath the cooktop is too small for conventional ovens.

The object of the invention is, in particular but not limited thereto, to provide a generic system with improved properties regarding a construction. The object is achieved according to the invention by the features of claims 1 and 13, whilst advantageous embodiments and developments of the invention may be derived from the subclaims.

The invention is based on a cooking-appliance system, advantageously on an induction-cooking-appliance system, having at least one cooktop, which has at least one cooktop panel with at least one extractor aperture for suction extraction of vapors which are produced in an operating state, having at least one extractor unit, which is provided for suction extraction of the vapors through the extractor aperture, and having at least one oven.

It is proposed that in an installation position the oven is arranged beneath the cooktop, and namely advantageously in the horizontal direction and/or in the vertical direction, preferably both in the horizontal direction and in the vertical direction.

Advantageously, an optimized construction may be achieved by means of such an embodiment. Advantageously, a compact embodiment may be achieved, in which advantageously three functions, and namely for example the cooktop and the extractor unit and the oven, may be integrated in one appliance. Advantageously, a user may be provided with a large number of functions for operating the cooktop and oven in the smallest space and/or long distances may be saved. Advantageously, an embodiment may be provided which may also be specifically used in small kitchens and/or in kitchens with an exhaust air line which is accessible only with difficulty.

A “cooking-appliance system” is advantageously intended to be understood to mean a system which has at least one cooking-appliance object and/or at least one cooking appliance and/or at least one cooking-appliance accessory object and which additionally could have, for example, at least one kitchen object and/or at least one further structural unit, which is advantageously configured differently from a cooking-appliance object and/or from a cooking appliance and/or from a cooking-appliance accessory object. A “cooking-appliance object” is advantageously intended to be understood to mean at least a part, in particular a subassembly, of a cooking appliance, advantageously of an induction-cooking appliance. A “cooking-appliance accessory object” is advantageously intended to be understood to mean an object which is provided for an application and/or for a use with a cooking appliance and/or which is configured as an accessory for a cooking appliance. A “kitchen object” is advantageously intended to be understood to mean an object which is provided for an application and/or for a use and/or for an arrangement in a kitchen, and namely for example for a processing and/or treatment and/or storage of at least one food. At least one cooking appliance could be, for example, an oven and/or a cooktop and/or a microwave and/or a grill appliance.

The cooktop advantageously has at least one cooktop heating unit which is advantageously provided for heating at least one item of cookware and/or at least one food to be cooked. For example, the cooktop could have at least two, in particular at least three, advantageously at least four, particularly advantageously at least six, preferably at least eight and particularly preferably a plurality of cooktop heating units. At least some of the cooktop heating units and advantageously the cooktop heating units could be arranged, for example, in the form of a conventional cooktop in which individual heating zones are fixedly predetermined, and could be identified, for example, by lighting and/or by coating and/or by silk screen printing. Advantageously, at least some of the cooktop heating units and particularly advantageously the cooktop heating units could be arranged in the form of a matrix and could be provided for a flexible formation of heating zones.

The cooktop heating unit could be configured, for example, as a heating unit which could be provided, for example, for heating by means of gas and/or for an inductive heating and/or for a resistive heating.

A “heating unit” is advantageously intended to be understood to mean a unit which is provided to supply energy in at least one operating state to at least one object to be heated, advantageously for the purpose of heating the object to be heated. The object to be heated could have, for example, at least one item of cookware and/or at least one food to be cooked and/or could be configured as such. For example, the heating unit could be configured as a resistance heating unit and could be provided, for example, to convert energy into heat and to supply this heat to the object to be heated for the purpose of heating the object to be heated. For example, alternatively or additionally, the heating unit could be configured, for example, as an induction heating unit and could be provided, for example, to supply energy in the form of an electromagnetic alternating field to the object to be heated, which could be advantageously configured as an item of cookware, wherein the energy supplied to the object to be heated could be converted, for example, into heat in the object to be heated.

The cooktop advantageously has at least one cooktop control unit which is advantageously provided at least for controlling and/or for regulating the cooktop heating unit. For example, the cooktop control unit could have at least one computing unit and, for example, in addition to the computing unit at least one memory unit with a control and/or regulating program stored therein, which could be provided to be executed, for example, by the computing unit.

A “cooktop panel” is advantageously intended to be understood to mean a unit which is provided in at least one operating state for positioning an item of cookware and/or for positioning at least one food to be cooked for the purpose of heating. For example, the hob panel could be provided to form a part of a hob external housing, advantageously of the cooktop. Advantageously, in an installation position the cooktop panel forms a part of the cooktop external housing facing a user. The cooktop panel could be configured, for example, at least to a large part from glass and/or from glass ceramic and/or from Neolith and/or from Dekton and/or from wood and/or from marble and/or from stone, for example from natural stone, and/or from laminated material and/or from metal and/or from plastics and/or from ceramic.

The cooktop could have, for example, at least one cooktop housing unit which could be provided, for example, to form a part of a cooktop external housing, advantageously of the cooktop. For example, in an installation position the cooktop housing unit could form a part of the cooktop external housing facing away from a user. In an installation position, the cooktop housing unit and the cooktop panel could jointly form, for example, the cooktop external housing, advantageously of the cooktop.

The extractor aperture could be configured, for example, as an aperture which is at least partially arranged in the cooktop panel and could be surrounded and/or defined and/or delimited, for example, by the cooktop panel. When viewed perpendicular to a main extension plane of the cooktop panel, the extractor aperture could be surrounded and/or defined and/or delimited by the cooktop panel, for example, over an angular range of at least 90°, in particular of at least 180°, advantageously of at least 270°, particularly advantageously of at least 300°, preferably of at least 330°, and particularly preferably of at least 350°. The extractor aperture could be arranged, for example, on the edge in the cooktop panel. Advantageously, the extractor aperture is arranged centrally in the cooktop panel and namely advantageously relative to a width extension of the cooktop panel and/or relative to a depth extension of the cooktop panel.

“At least to a large part” is advantageously intended to be understood to mean a proportion, in particular a mass proportion and/or a volume proportion and/or a proportion of a number, of at least 70%, in particular of at least 80%, advantageously of at least 90% and preferably of at least 95%. A “main extension plane” of a structural unit is advantageously intended to be understood to mean a plane which is parallel to a largest side surface of a smallest imaginary cuboid which only just fully encloses the structural unit, and advantageously runs through the central point of the cuboid. An “extension” of an object is advantageously intended to be understood to mean a maximum spacing between two points of a perpendicular projection of the object onto a plane.

A “depth extension” of an object is advantageously intended to be understood to mean an extension of the object in a depth direction. The depth direction could be oriented, for example, at least substantially parallel to a main extension plane of the cooktop panel. In an installation position, the depth direction could be oriented, for example, from a region of the cooktop facing a user, into a region of the cooktop facing away from a user.

A “width extension” of an object is advantageously intended to be understood to mean an extension of the object in a width direction. The width direction could be oriented, for example, at least substantially parallel to a main extension plane of the cooktop panel. In an installation position the width direction could be oriented, for example, at least substantially perpendicular to a depth direction of the object.

“Substantially parallel” is intended to be understood to mean here, in particular, an orientation of a direction relative to a reference direction, in particular in a plane, wherein the direction has a deviation relative to the reference direction in particular of a maximum of 8°, advantageously of a maximum of 5°, and particularly advantageously of a maximum of 2°. The expression “substantially perpendicular” is advantageously intended to define here an orientation of a direction relative to a reference direction, wherein the direction and the reference direction, in particular when viewed in a projection plane, enclose an angle of 90°, and the angle has a maximum deviation of, in particular, a maximum of 8°, advantageously a maximum of 5°, and particularly advantageously a maximum of 2°.

An “extractor unit” is advantageously intended to be understood to mean a unit which is provided to suction and/or to filter vapors which are produced in at least one operating state and which is advantageously provided at least to transport these vapors away from a cooking region. The extractor unit advantageously has at least one grease filter which is provided to absorb at least substantially grease particles released in the vapors which are produced in at least one operating state, and/or to remove said grease particles at least substantially from the vapors. Advantageously, the extractor unit has at least one ventilation element which is provided in at least one operating state to provide at least one suction flow for vapors which are produced in the operating state, and advantageously at least to transport the suctioned vapors away from the cooking region. For example, the extractor unit could be provided to divert vapors, which are produced in the operating state, from the cooking region and additionally from a cooking space, and for example supply said vapors to at least one exhaust air line. Alternatively, for example, the extractor unit could be provided to transport the vapors, which are produced in the operating state, from the cooking region into at least one further partial region of the cooking space. A “cooking region” is advantageously intended to be understood to mean a partial region of a cooking space in which a cooking process takes place in at least one operating state and in which advantageously vapors which are produced during the cooking process escape from a heated item of cookware and which in an installation position advantageously extends at least to a large part above the cooktop panel. A “cooking space” is advantageously intended to be understood to mean a space, particularly advantageously a room, in which a cooktop comprising the cooktop device is positioned and/or arranged. For example, the cooking space could be a kitchen.

In an operating state, the extractor unit advantageously suctions the vapors which are produced in the operating state through the extractor aperture, at least to a large part, and namely advantageously from the cooking region.

The oven advantageously has at least one muffle which advantageously at least partially delimits and/or defines at least one cooking space. For example, the muffle could at least substantially delimit and/or define the cooking space together with at least one oven appliance door of the oven in an operating state in which the oven appliance door, for example, could be in a closed state.

The oven advantageously has at least one oven heating unit which is advantageously provided for heating at least one item of cookware and/or at least one food to be cooked. For example, the oven could have at least two, advantageously at least three, preferably at least four and particularly preferably a plurality of oven heating units. At least some of the oven heating units and advantageously the oven heating units could be provided, for example, for heating in the form of top heat and/or bottom heat and in an installation position could be arranged, for example, above and/or beneath the muffle. For example, some of the oven heating units and advantageously the oven heating unit could be arranged in a rear region, for example, of the muffle and/or of the oven, and namely, for example, in a region of at least one oven fan unit of the oven.

The oven heating unit could be configured, for example, as a heating unit which could be provided, for example, for an inductive heating and/or for a resistive heating.

In an installation position, the oven advantageously is at a shorter distance from a substrate than the cooktop. The substrate could for example be a floor, for example flooring, and/or a positioning surface on which at least one housing unit could be positioned. When viewed perpendicular to a main extension plane of the cooktop panel, in an installation position the cooktop and the oven are advantageously arranged so as to overlap at least in some sections. For example, when viewed perpendicular to a main extension plane of the cooktop panel, in an installation position a surface spanned by the cooktop and a surface spanned by the oven could be arranged so as to overlap by a proportion of at least 50%, for example of at least 60%, advantageously of at least 70%, particularly advantageously of at least 80%, preferably of at least 90% and particularly preferably of at least 95% of a surface extension of a smaller of the surfaces.

Particularly advantageously, the cooking-appliance system has at least one appliance unit which advantageously has at least the cooktop. The appliance unit advantageously has at least the oven. The appliance unit advantageously has at least the extractor unit.

“Provided” is intended to be understood to mean specifically programmed, designed and/or equipped. An object being provided for a specific function is intended to be understood to mean that the object fulfils and/or performs this specific function in at least one use state and/or operating state.

It is also proposed that the extractor unit, for example at least in a mounted state and/or in an installed state, is arranged between the cooktop panel and the oven, and namely advantageously in the horizontal direction and/or in the vertical direction, preferably both in the horizontal direction and in the vertical direction. When viewed perpendicular to a main extension plane of the cooktop panel, in an installation position the extractor unit is advantageously arranged so as to overlap at least in some sections with the cooktop and/or with the oven. When viewed perpendicular to a main extension plane of the cooktop panel, in an installation position a surface spanned by the extractor unit could be arranged, for example, so as to overlap with a surface spanned by the cooktop and/or with a surface spanned by the oven, and namely, for example, by a proportion of at least 50%, for example of at least 60%, advantageously of at least 70%, particularly advantageously of at least 80%, preferably of at least 90% and particularly preferably of at least 95% of a surface extension of a smaller one of the surfaces. As a result, advantageously a particularly compact embodiment and/or an advantageous construction may be provided.

In an installation position the extractor unit could be arranged, for example, beneath the cooktop and could be arranged and/or fastened, for example, on the cooktop housing unit. For example, the extractor unit could be configured separately from the cooktop and/or independently of the cooktop. Preferably, the cooktop has the extractor unit. The extractor unit could be integrated, for example, in the cooktop and/or in the cooktop housing unit. As a result, advantageously a protected arrangement of the extractor unit and/or a compact embodiment may be achieved. For example, extraction distances, via which the extractor unit could suction the vapors which are produced in the operating state, may be kept short, whereby low energy consumption and/or low losses and/or low cleaning effort could be permitted, for example.

It is also proposed that the cooktop has at least one and advantageously at least the cooktop housing unit, which together with the cooktop panel delimits a cooktop interior in which the extractor unit is arranged at least to a large part. The cooktop interior could be configured, for example, as a hollow space and could be provided for storing cooktop components. At least one cooktop component could be, for example, the cooktop heating unit and/or the cooktop control unit and/or at least one cooktop user interface and/or at least one cooktop electronics unit. As a result, advantageously a particularly advantageous construction may be achieved. The extractor unit may be advantageously mounted securely in the cooktop interior, whereby for example a low probability of damage to the extractor unit, for example during the course of transport and/or mounting, may be achieved.

It is also proposed that the cooktop has a height extension of a maximum of 300 mm, in particular of a maximum of 290 mm, in particular of a maximum of 270 mm, advantageously of a maximum of 250 mm, particularly advantageously of a maximum of 220 mm and preferably of a maximum of 210 mm. For example, the cooktop could have a height extension of at least 150 mm, in particular of at least 170 mm, in particular of at least 190 mm, advantageously of 200 mm, particularly advantageously of at least 205 mm, and preferably of at least 210 mm. A “height extension” of an object is advantageously intended to be understood to mean an extension of the object in a height direction. In an installation position the height direction could be oriented, for example, at least substantially perpendicular to a main extension plane of the cooktop panel and/or to a substrate. For example, the height direction could be oriented at least substantially perpendicular to the width direction and/or to the depth direction. As a result, advantageously a compact embodiment may be provided.

It is also proposed that the cooking-appliance system has at least one housing unit which at least partially surrounds the cooktop and the oven. The housing unit is advantageously configured as an appliance housing unit, which is advantageously common to the cooktop and the oven, and advantageously at least partially defines an external appliance housing. For example, the cooktop and/or the oven could at least partially define, for example in each case, an external appliance housing. The cooktop could at least partially define an external appliance housing, for example by means of the cooktop panel, advantageously by means of a side of the cooktop panel facing the user. The oven could at least partially define an external appliance housing, for example by means of the appliance doors, advantageously by means of a side of the appliance doors facing the user. The phrase that the housing unit “at least partially” surrounds the cooktop and the oven is understood to mean that the housing unit in each case surrounds at least a part of the cooktop and at least a part of the oven, and for example at least a further part of the cooktop, for example the cooktop panel, and/or the oven, for example the appliance door, could be free from being surrounded by the housing unit. As a result, advantageously a high degree of stability and/or an at least partially protected and/or secure arrangement of the cooktop and/or oven may be achieved. Advantageously, a simple transport of the cooktop and oven may be permitted.

For example, the housing unit could be provided for installation, for example, in at least one item of furniture, which for example could be part of the cooking-appliance system and which could be arranged for example in the cooking space and which could form, for example together with the oven and the cooktop, a built-in appliance. Preferably, the housing unit is provided for positioning on a floor. The housing unit could be configured, for example, as an external housing unit, advantageously of the appliance unit, and advantageously at least partially form an external housing of the appliance unit. For example, the housing unit could form, together with the oven and the cooktop, the external housing of the appliance unit. The appliance unit could be configured, for example, as a built-in appliance. Advantageously, the appliance unit could be configured as a freestanding appliance. The housing unit advantageously has at least one support unit which is provided for support on the floor and which has, for example, at least four support elements for support on the floor. The support elements could be configured, for example, as adjusting supports. As a result, advantageously a high degree of flexibility may be achieved and namely, for example, regarding a positioning of the housing unit in the cooking space.

It is also proposed that the housing unit has a height extension of a maximum of 1000 mm, in particular of a maximum of 980 mm, in particular of a maximum of 960 mm, advantageously of a maximum of 940 mm, particularly advantageously of a maximum of 920 mm, preferably of a maximum of 910 mm and particularly preferably of a maximum of 900 mm. For example, the housing unit could have a height extension of at least 550 mm, in particular of at least 600 mm, in particular of at least 650 mm, advantageously of at least 700 mm, particularly advantageously of at least 750 mm, preferably of at least 780 mm and particularly preferably of at least 800 mm. As a result, advantageously a compact embodiment and/or a small space requirement may be achieved, whereby advantageously an arrangement may be permitted even in small spaces and/or rooms.

It is also proposed that the oven has a height extension of a maximum of 550 mm, in particular of a maximum of 525 mm, in particular of a maximum of 500 mm, advantageously of a maximum of 480 mm, particularly advantageously of a maximum of 470 mm, preferably of a maximum of 460 mm and particularly preferably of a maximum of 455 mm. For example, the oven could have a height extension of at least 350 mm, in particular of at least 360 mm, in particular of at least 380 mm, advantageously of at least 400 mm, particularly advantageously of at least 420 mm, preferably of at least 440 mm and particularly preferably of at least 445 mm. As a result, advantageously an optimized compactness may be provided. For example, an optimal compromise between a compactness and a sufficient oven size could be achieved in which advantageously size-related limitations could be avoided.

Preferably, the oven has at least one oven user interface. In an installation position the oven user interface could be arranged beneath the oven, for example relative to a height direction. For example, alternatively or additionally the oven user interface could be integrated at least to a large part, for example, in at least one oven housing unit of the oven.

Preferably, the oven has at least one oven user interface which, in a viewing direction which is oriented parallel to a main extension plane of the cooktop panel, is arranged so as to overlap at least in some sections with the cooktop. The oven advantageously has at least one oven control unit which is provided at least for controlling and/or regulating at least one and advantageously at least the oven heating unit. The oven user interface is advantageously provided for a communication, for example of the oven control unit, with a user. For example, the oven user interface could be provided for an input and/or output of at least one oven operating parameter. The oven operating parameter could comprise, for example, at least one heating level and/or at least one heating power and/or at least one type of cooking and/or at least one cooking program. The phrase that the oven user interface, in a viewing direction which is oriented parallel to a main extension plane of the cooktop panel, is arranged so as to overlap “at least in some sections” with the cooktop, is advantageously intended to be understood to mean that the oven user interface has at least one section which is arranged so as to overlap with the cooktop in the viewing direction and could have, for example, at least one further section which could be arranged without an overlap with the cooktop in the viewing direction. In an installation position the oven user interface is advantageously arranged above the muffle relative to a height direction. As a result, advantageously a simple operability of the oven may be provided, in which the oven user interface may be arranged relatively high up in relation to the height direction and thus a user may be advantageously spared from stooping. A user may advantageously be permitted to keep the oven user interface continuously in the field of view and thus to achieve, for example, a simple operation of the oven.

It is also proposed that the oven has at least one muffle and at least one oven electronics unit which in an installation position is advantageously arranged beneath the muffle relative to a height direction. The oven electronics unit could be provided, for example, for controlling and/or regulating at least one oven function and/or particularly advantageously at least for one oven main function. Advantageously, the oven control unit is part of the oven electronics unit. The oven electronics unit could have, for example, at least one drive motor which could be provided, for example, for driving at least one oven fan unit. In an installation position the oven electronics unit could be arranged, for example, spaced apart from the cooktop relative to the height direction. In an installation position the muffle could be arranged, for example, between the cooktop and the oven electronics unit relative to the height direction. The oven electronics unit could, for example, alternatively or additionally be arranged, for example, in the vicinity of the oven user interface and advantageously on a side facing away from the user and/or on a side of the oven user interface facing the cooktop. For example, when viewed in a viewing direction which is oriented parallel to a main extension plane of the cooktop panel, the oven electronics unit could be arranged so as to overlap at least in some sections with the cooktop. As a result, advantageously a secure and/or protected arrangement of the oven electronics unit may be permitted and namely advantageously in an otherwise unused region. In a structurally simple manner, for example in the case of a cooktop configured as an induction cooktop, an optimal shielding of the oven electronics unit could be achieved relative to electromagnetic radiation which could be provided by at least one induction heating unit of the cooktop. Advantageously, due to a higher position of the oven, advantageously a simple operation of the oven may be achieved, and namely for example avoiding the unnecessary stooping of a user. The cooktop and the oven may be arranged in the vicinity of one another, for example relative to a vertical direction, whereby advantageously a compact embodiment may be achieved which, for example, could appear compact to a user. Advantageously, due to the arrangement of the oven electronics unit beneath the muffle, advantageously sufficient space may be provided above the muffle for the cooktop and/or for the extractor unit and, for example, even when the oven is arranged at a sufficiently high level.

When viewed perpendicular to a main extension plane of the cooktop panel, for example, the cooktop panel could have a width extension of a maximum of 110 cm, in particular of a maximum of 105 cm, in particular of a maximum of 100 cm, advantageously of a maximum of 95 cm, particularly advantageously of a maximum of 90 cm, preferably of a maximum of 85 cm and particularly preferably of a maximum of 80 cm. Preferably, when viewed perpendicular to a main extension plane of the cooktop panel, the cooktop panel has a width extension of a maximum of 75 cm, in particular of a maximum of 72 cm, in particular of a maximum of 70 cm, advantageously of a maximum of 67 cm, particularly advantageously of a maximum of 65 cm, preferably of a maximum of 62 cm and particularly preferably of a maximum of 60 cm. When viewed perpendicular to a main extension plane of the cooktop panel, for example, the cooktop panel could have a width extension of at least 30 cm, in particular of at least 35 cm, in particular of at least 40 cm, advantageously of at least 45 cm, particularly advantageously of at least 50 cm, preferably of at least 55 cm and particularly preferably of at least 60 cm. When viewed perpendicular to a main extension plane of the cooktop panel, for example, the cooktop panel could have a depth extension of a maximum of 75 cm, in particular of a maximum of 72 cm, in particular of a maximum of 70 cm, advantageously of a maximum of 67 cm, particularly advantageously of a maximum of 65 cm, preferably of a maximum of 62 cm and particularly preferably of a maximum of 60 cm. When viewed perpendicular to a main extension plane of the cooktop panel, for example, the cooktop panel could have a depth extension of at least 30 cm, in particular of at least 35 cm, in particular of at least 40 cm, advantageously of at least 45 cm, particularly advantageously of at least 50 cm, preferably of at least 55 cm and particularly preferably of at least 60 cm. As a result, advantageously a high level of user convenience may be provided even in a cooktop with small dimensions, for example by the extractor unit being arranged beneath the cooktop, whereby a high level of customer satisfaction could be achieved, for example, for a user.

It is also proposed that the cooking-appliance system has at least one exhaust air duct which is arranged in terms of fluid technology downstream of the extractor unit and is provided for discharging the vapors. The exhaust air duct could be provided, for example, for connecting to at least one exhaust air line and particularly advantageously to differently designed exhaust air lines, whereby advantageously a high degree of flexibility could be achieved during mounting. The exhaust air line could be, for example, a household exhaust air line. The household exhaust air line could be provided, for example, for diverting and/or discharging the vapors from the cooking space. For example, the exhaust air duct could produce a connection in terms of fluid technology between the extractor unit and the exhaust air line. The exhaust air duct could have, for example, at least one exhaust air interface which could be provided for connecting to at least one corresponding exhaust air interface of the exhaust air line. For example, the exhaust air duct could be at least partially integrated in the housing unit and advantageously at least partially in the appliance unit. Alternatively or advantageously additionally, for example, the exhaust air duct could be at least partially arranged, for example, outside the housing unit and advantageously at least one section of the exhaust air duct which could be arranged at least partially inside the housing unit, could be connected in terms of fluid technology to the exhaust air line. As a result, advantageously a possibility for connecting to an exhaust air line may be integrated. Advantageously a simple mounting and/or commissioning may be achieved, and namely amongst other things, by a simple connection to an exhaust air line.

The appliance unit could be arranged in an installation position, for example in the form of a kitchen island, in which advantageously a conventional extractor hood unit could be dispensed with, and namely advantageously due to the extractor unit being integrated in the appliance unit and advantageously in the cooktop. For example, due to a compact embodiment of the appliance unit, for example due to the width extension of the cooktop panel and/or due to the depth extension of the cooktop panel, the appliance unit could be mounted even in small kitchens and/or in small attic apartments in which, for example, any available space has to be utilized.

A particularly optimized construction may be advantageously achieved by a method for mounting an appliance system according to the invention, having at least one cooktop, which has at least one cooktop panel with at least one extractor aperture for suction extraction of vapors which are produced in an operating state, having at least one extractor unit, which is provided for suction extraction of the vapors through the extractor aperture, and having at least one oven, wherein the oven is arranged beneath the cooktop.

The cooking-appliance system is not intended to be limited here to the above-described use and embodiment. In particular, the cooking-appliance system may have a number of individual elements, components and units deviating from the number mentioned herein.

Further advantages emerge from the following description of the drawing. Exemplary embodiments of the invention are shown in the drawing. The drawing, the description and the claims contain numerous features in combination. The person skilled in the art will also expediently consider the features individually and combine them to form further meaningful combinations.

### IN THE DRAWING

FIG. 1 shows a cooking-appliance system with a cooktop and with an extractor unit in a schematic plan view,

FIG. 2 shows the cooking-appliance system with the cooktop, with an oven and with a housing unit in a schematic perspective view,

FIG. 3 shows the cooking-appliance system of FIG. 2 in which a view of the housing unit has been omitted,

FIG. 4 shows a possibility for connecting an exhaust air duct of the cooking-appliance system to an exhaust air line in a schematic view,

FIG. 5 shows a further possibility for connecting the exhaust air duct to an exhaust air line in a schematic view,

FIG. 6 shows a further possibility for connecting the exhaust air duct to an exhaust air line in a schematic view,

FIG. 7 shows a diagram in which a method for operating the cooking-appliance system is shown in a schematic view and

FIG. 8 shows an alternative cooking-appliance system with a cooktop and with an oven in a schematic perspective view, wherein a view of a housing unit has been omitted.

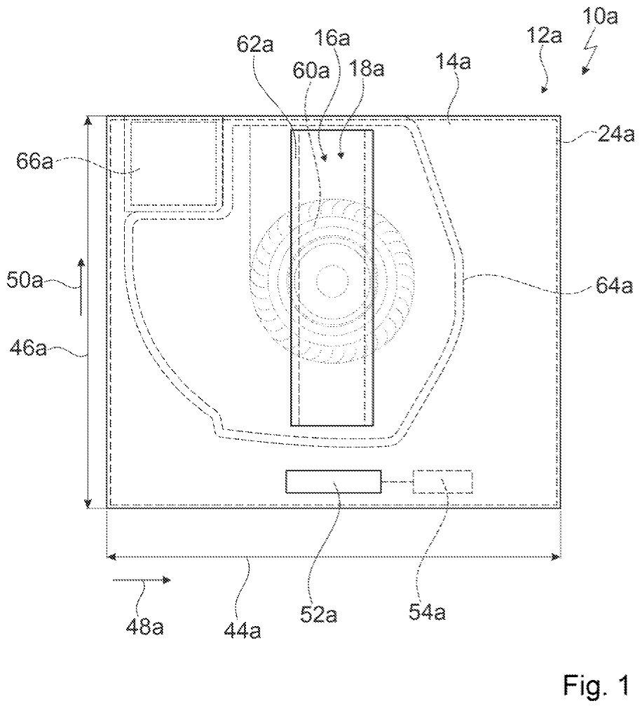

FIG. 1 shows by way of example a cooking-appliance system 10a which is advantageously configured as an induction-cooking-appliance system. For example, the cooking-appliance system 10a could be alternatively or additionally configured, for example, as a gas cooking-appliance system and/or as a resistance heating cooking-appliance system.

The cooking-appliance system 10a advantageously has at least one, and for example exactly one, cooktop 12a. The cooktop 12a is advantageously provided for heating an item of cookware which is, for example, positioned thereon (not shown).

For heating the item of cookware positioned thereon, for example, the cooktop 12a has at least one cooktop heating unit (not shown). The cooktop heating unit is advantageously provided for heating an item of cookware and/or food to be cooked. For example, the cooktop 12a could have at least two, in particular at least three, advantageously at least four, particularly advantageously at least six, preferably at least eight and particularly preferably a plurality of cooktop heating units. In the present exemplary embodiment, the cooktop 12a has, for example, a plurality of cooktop heating units which could be arranged, for example, in the form of a matrix and provided for a flexible formation of heating zones. Only one of the cooktop heating units is described hereinafter by way of example.

The cooktop 12a advantageously has at least one, and for example exactly one, cooktop panel 14a. The cooktop panel 14a is advantageously provided for positioning an item of cookware and/or for positioning food to be cooked. In a mounted state, the cooktop panel 14a forms, for example, a part of a cooktop external housing and namely, for example, a cooktop external housing of the cooktop 12a.

In an installation position the cooktop heating unit is advantageously arranged beneath the cooktop panel 14a. The cooktop heating unit is advantageously provided to heat an item of cookware positioned on the cooktop panel 14a above the cooktop heating unit. The cooktop heating unit could be configured, for example, as an induction heating unit.

Advantageously, the cooktop panel 14a has, for example, at least one, and exactly one, extractor aperture 16a. In the present exemplary embodiment, the extractor aperture 16a is arranged at least substantially centrally relative to a width direction 48a. For example, the extractor aperture 16a could be arranged at least substantially centrally relative to a depth direction 50a. In the present exemplary embodiment, the extractor aperture 16a extends relative to the depth direction 50a over a large part of a depth extension 46a of the cooktop panel 14a.

When viewed perpendicular to a main extension plane of the cooktop panel 14a, the cooktop panel 14a could have, for example, a width extension 44a of at least substantially 60 cm. When viewed perpendicular to a main extension plane of the cooktop panel 14a, the cooktop panel 14a could have, for example, a depth extension 46a of at least substantially 60 cm. For example, a compact embodiment could be achieved by a cooktop panel 14a having such dimensions.

The cooktop 12a could advantageously have at least one, and for example exactly one, user interface 52a which could be provided, for example, for an input and/or selection of operating parameters, such as for example a heating power and/or a heating power density and/or a heating zone. The user interface 52a could be provided, for example, for an output of a value of an operating parameter to a user.

The cooktop 12a advantageously has at least one, and for example exactly one, cooktop control unit 54a. The cooktop control unit 54a is provided, for example, as a function of operating parameters input by means of the user interface 52a to perform actions and/or to change settings. In an operating state, the cooktop control unit 54a could control and/or regulate, for example, an energy supply to the cooktop heating unit.

The extractor aperture 16a is advantageously provided for the suction extraction of vapors which are produced in an operating state. In an operating state, the vapors which are produced in the operating state advantageously pass through the extractor aperture 16a and thus, for example, enter a cooktop interior 24a.

The cooking-appliance system 10a advantageously has at least one, and for example exactly one, extractor unit 18a. The extractor unit 18a is provided for the suction extraction of vapors through the extractor aperture 16a. In an operating state, the extractor unit 18a suctions vapors which are produced in the operating state through the extractor aperture 16a. When viewed perpendicular to a main extension plane of the cooktop panel 14a, the extractor unit 18a could be arranged, for example, so as to overlap at least in some sections with the extractor aperture 16a.

The extractor unit 18a advantageously has at least one, and for example exactly one, fan wheel 60a. The fan wheel 60a could be arranged at least to a large part, for example, beneath the cooktop panel 14a. In an operating state, the extractor unit 18a at least partially suctions vapors, which are produced in an operating state, from a cooking region, for example by means of the fan wheel 60a. The cooking region could be, for example, a region which could be located in an installation position above the cooktop panel 14a.

The cooktop 12a could advantageously have at least one, and for example exactly one, cover unit 62a (see FIG. 1). In an installation position the cover unit 62a could be arranged, for example, above the extractor aperture 16a. When viewed perpendicular to a main extension plane of the cooktop panel 14a, the cover unit 62a could be arranged to cover the extractor aperture 16a, for example at least in some sections and advantageously so as to overlap at least to a large part with the extractor unit 18a. In the depth direction 50a and/or in the width direction 48a the cover unit 62a could have, for example, at least one extension which could be at least as large as an extension of the extractor aperture 16a in the depth direction 50a and/or in the width direction 48a.

The extractor unit 18a could advantageously have at least one, and for example exactly one, air guiding unit 64a. In an operating state, the air guiding unit 64a could repel, for example, vapors which are produced in the operating state from at least one cooktop electronics unit of the cooktop 12a. In a mounted state, for example, the air guiding unit 64a could substantially entirely surround the fan wheel 60a relative to a central point and/or point of gravity of the fan wheel 60a, when viewed in a plane which could be oriented, for example, parallel to a main extension plane of the cooktop panel 14a.

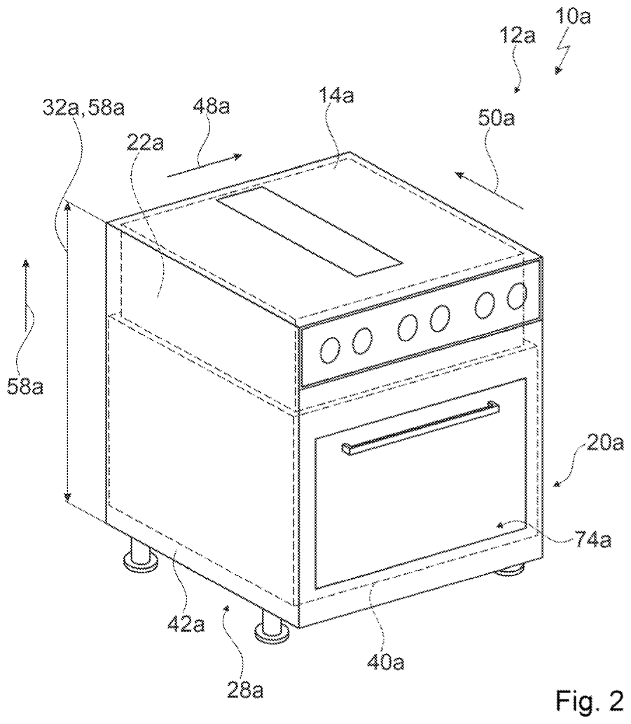

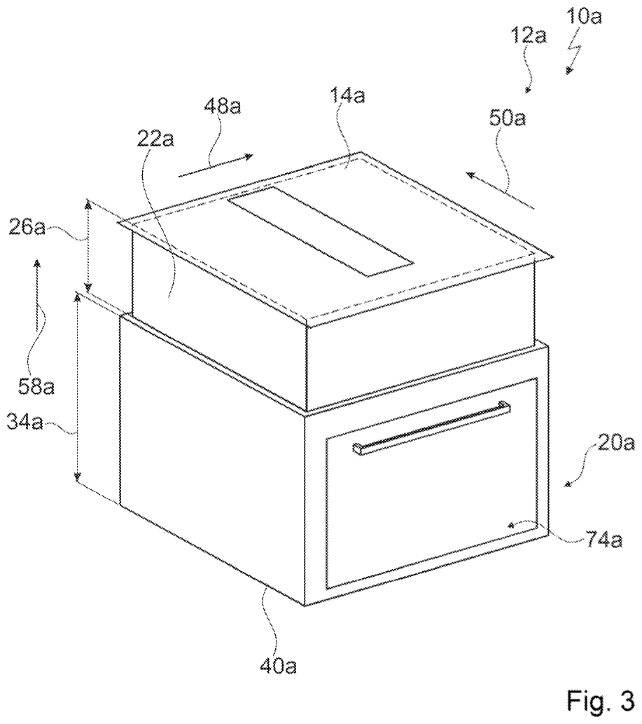

The cooking-appliance system 10a advantageously has at least one, and for example exactly one, oven 20a (see FIGS. 2 and 3). The oven 20a is provided for heating food to be cooked and/or an item of cookware (not shown).

For the heating, the oven 20a could have, for example, at least one oven heating unit (not shown). The oven heating unit is advantageously provided for heating an item of cookware and/or food to be cooked. For example, the oven 20a could have at least two, advantageously at least three, preferably at least four and particularly preferably a plurality of oven heating units. Only one oven heating unit is described hereinafter by way of example.

The oven 20a advantageously has at least one, and for example exactly one, muffle 40a. The muffle 40a is advantageously provided for introducing food to be cooked and/or an item of cookware. For closing the muffle 40a, the oven 20a advantageously has at least one, and for example exactly one, oven door 74a. In an operating state in which the oven door 74a is advantageously in a closed state, the oven door 74a advantageously closes the muffle 40a.

Advantageously, the oven 20a has at least one, and for example exactly one, oven electronics unit 42a. In the present exemplary embodiment, in an installation position the oven electronics unit 42a is advantageously arranged beneath the muffle 40a. In an installation position the oven electronics unit 42a is advantageously arranged on a side of the muffle 40a facing away from the cooktop 12a and/or the extractor unit 18a.

In an installation position the oven 20a is advantageously arranged beneath the cooktop panel 14a and particularly advantageously beneath the cooktop 12a. In an installation position the oven 20a is advantageously arranged beneath the extractor unit 18a.

In an installation position the extractor unit 18a is advantageously arranged beneath the cooktop panel 14a. Particularly advantageously, in an installation position the extractor unit 18a is arranged between the cooktop panel 14a and the oven 20a.

Advantageously, the extractor unit 18a is part of the cooktop 12a. The cooktop 12a advantageously has the extractor unit 18a. Advantageously, the cooktop 12a has at least one cooktop housing unit 22a (see FIG. 3). The cooktop housing unit 22a forms, for example, a part of the cooktop external housing and namely, for example, the cooktop external housing of the cooktop 12a. Advantageously, the cooktop housing unit 22a together with the cooktop panel 14a forms the cooktop external housing and namely, for example, the cooktop external housing of the cooktop 12a.

The cooktop housing unit 22a, advantageously together with the cooktop panel 14a, delimits the cooktop interior 24a. Advantageously, the extractor unit 18a is arranged and/or integrated at least to a large part in the cooktop interior 24a. In an installation position the extractor unit 18a is arranged, for example, at least to a large part between the housing floor of the cooktop housing unit 22a and the cooktop panel 14a.

The cooktop 12a advantageously has a height extension 26a of at least substantially 210 mm, advantageously from an upper face of the cooktop panel 14a to a floor of the cooktop housing unit 22a. For example, the cooktop 12a could be configured as a compact cooktop and namely, in particular, due to the small height extension 26a, in spite of the integration of the extractor unit 18a.

Advantageously, the oven 20a has a height extension 34a of at least substantially 450 mm. For example, the oven 20a could be configured as a compact oven and namely, in particular, due to the small height extension 34a.

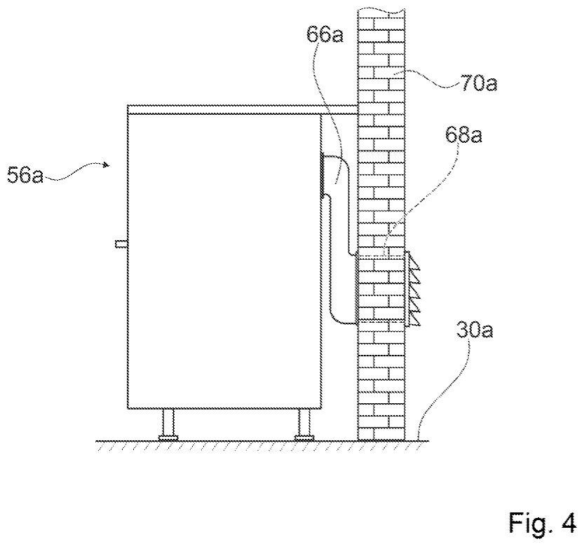

The cooking-appliance system 10a advantageously has at least one, and for example exactly one, appliance unit 56a (see FIGS. 4 to 6). The appliance unit 56a has, for example, the cooktop 12a and for example the oven 20a. For example, the appliance unit 56a has the extractor unit 18a which is integrated, for example, in the cooktop 12a.

The cooking-appliance system 10a advantageously has at least one, and for example exactly one, housing unit 28a (see FIG. 2). The housing unit 28a is, for example, part of the appliance unit 56a. The appliance unit 56a has, for example, the housing unit 28a. The housing unit 28a at least partially surrounds the cooktop 12a and the oven 20a.

In the present exemplary embodiment, the housing unit 28a is advantageously provided for being positioned on a floor 30a. In an operating state the housing unit 28a is advantageously positioned on the floor 30a. In the present exemplary embodiment the housing appliance unit 56a is advantageously configured as a freestanding unit.

Advantageously, the housing unit 28a has a height extension 32a of at least substantially 850 mm. The appliance unit 56a, the external housing thereof for example forming the housing unit 28a, has for example the same height extension 32a, 58a as the housing unit 28a. For example, a height extension 32a of the housing unit 28a and a height extension 58a of the appliance unit 56a could be at least substantially identical and could be advantageously identical.

The cooking-appliance system 10a advantageously has at least one, and for example exactly one, exhaust air duct 66a (see FIG. 1). The exhaust air duct 66a could be, for example, at least partially part of the appliance unit 56a. The appliance unit 56 could at least partially have, for example, the exhaust air duct 66a.

The exhaust air duct 66a is advantageously arranged in terms of fluid technology downstream of the extractor unit 18a. Advantageously, in an installation position the exhaust air duct 66a is arranged in a region of the cooktop 12a facing away from the user and/or in a rear region of the cooktop 12a relative to the depth direction 50a. The exhaust air duct 66a is advantageously provided for discharging the vapors which are produced in the operating state.

In an operating state, for example, the air guiding unit 64a could guide vapors, which are produced in the operating state, into an external region and/or advantageously supply said vapors to at least one exhaust air duct 66a. In the present exemplary embodiment, in the installation position the external region is a rear region of the cooktop 12a and/or advantageously of the appliance unit 56a. The air guiding unit 64a and the exhaust air duct 66a could be connected together, for example, in terms of fluid technology.

The exhaust air duct 66a could be provided, for example, for connecting to at least one exhaust air line 68a and particularly advantageously to differently designed exhaust air lines 68a (see FIGS. 4 to 6), whereby advantageously a high degree of flexibility could be achieved during mounting. In the present exemplary embodiment, the exhaust air line 68a is advantageously a household exhaust air line. The exhaust air line 68a could be provided, for example, for diverting and/or for discharging vapors, which are produced in the operating state, from the cooking space.

Advantageously, the exhaust air duct 66a provides a connection in terms of fluid technology between the extractor unit 18a, advantageously between the air guiding unit 64a of the extractor unit 18a and the exhaust air line 68a. For example, for producing the connection in terms of fluid technology between the extractor unit 18a and the exhaust air line 68a, the exhaust air duct 66a could be arranged, for example, at least partially outside the housing unit 28a.

For example, the exhaust air line 68a could be at least partially integrated and/or arranged in at least one wall 70a, advantageously in at least one house wall (see FIG. 4). The exhaust air duct 66a could be provided, for example, for connecting to the exhaust air line 68a which is at least partially integrated in the wall 70a.

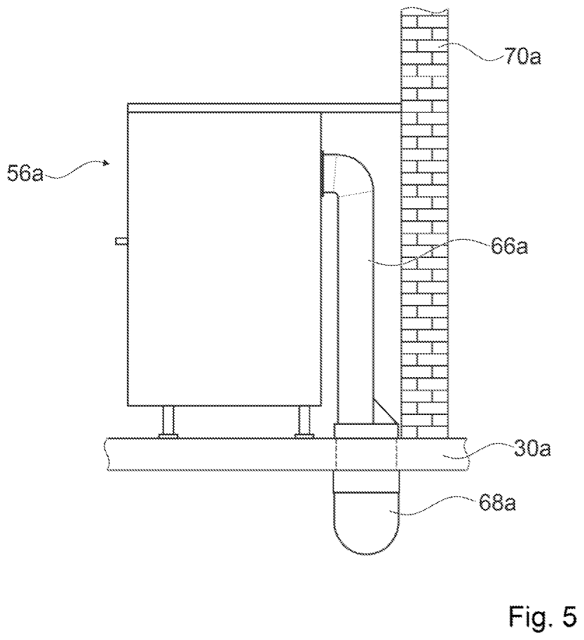

For example, the exhaust air line 68a could be at least partially integrated and/or arranged in the floor 30a which could be advantageously configured as a floor (see FIG. 5). The exhaust air line 68a which is, for example, integrated at least partially in the floor 30a, could for example be at least partially integrated in at least one item of furniture (not shown). The exhaust air duct 66a could be provided, for example, for connecting to the exhaust air line 68a which is at least partially integrated in the floor 30a and/or in the item of furniture.

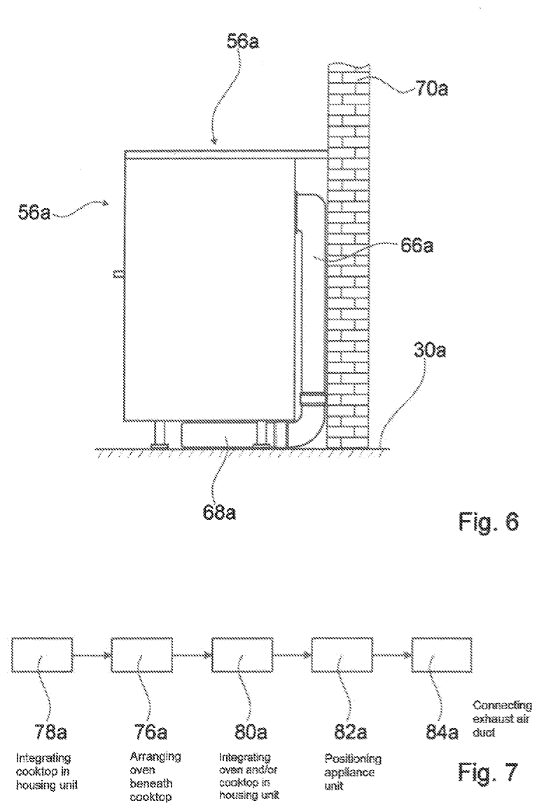

For example, in an installation position the exhaust air line 68a could be at least partially arranged above the floor 30a which could be advantageously configured as flooring and, for example, run at least partially beneath the appliance unit 56a and/or the item of furniture (see FIG. 6). The exhaust air duct 66a could be provided, for example, for connecting to the exhaust air line 68a which is arranged at least partially above the floor 30a and/or beneath the appliance unit 56a.

In FIGS. 4 to 6 embodiments have been described and/or shown by way of example in the case of an appliance unit 56a which is configured as a freestanding appliance. For example, in the case of an appliance unit 56a configured as a built-in appliance, embodiments could be configured in a similar manner thereto. The housing unit 28a of the appliance unit 56a could be surrounded, for example, by the item of furniture.

In a method for mounting the cooking-appliance system 10a, the oven 20a is arranged beneath the cooktop 12a, for example in at least one arrangement step 76a (see FIG. 7). By way of example, the cooktop 12a could be integrated in the housing unit 28a, for example in at least one integration step 78a. The integration step 78a could be arranged and/or take place, for example, chronologically before the arrangement step 76a.

For example, the oven 20a and/or the cooktop 12a could be integrated, for example, in the housing unit 28a in at least one further integration step 80a. The further integration step 80a could be arranged and/or take place, for example, chronologically after the arrangement step 76a. For example, the appliance unit 56a could be positioned in the cooking space and namely, for example, in the vicinity of the exhaust air line 68a in at least one positioning step 82a.

The exhaust air duct 66a could be connected, for example, to the exhaust air line 68a and/or attached to the exhaust air line 68a in at least one connecting step 84a. For example, in the connecting step 84a, a connection in terms of fluid technology could be produced by means of the exhaust air duct 66a, for example, between the extractor unit 18a and the exhaust air line 68a.

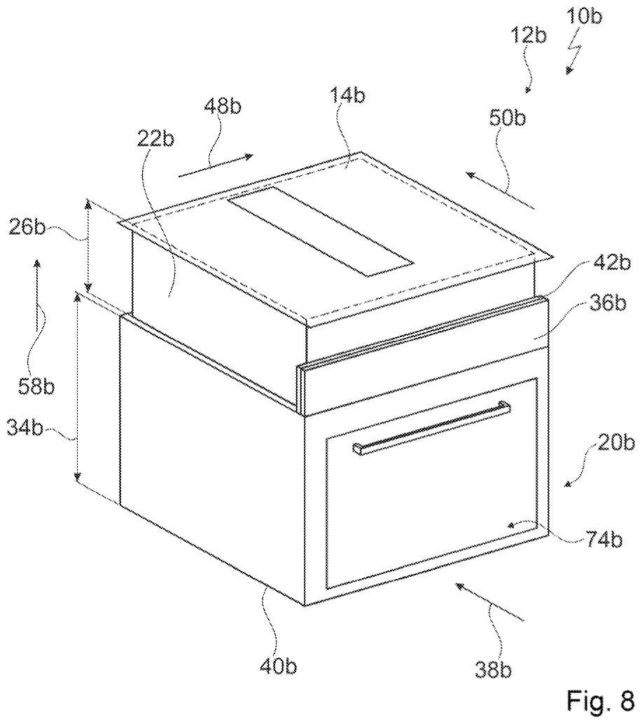

In FIG. 8 a further exemplary embodiment of the invention is shown. The following descriptions are substantially limited to the differences between the exemplary embodiments, wherein relative to components, features and functions remaining the same reference may be made to the description of the exemplary embodiment of FIGS. 1 to 7. For differentiating between the exemplary embodiments the letter a in the reference numerals of the exemplary embodiment of FIGS. 1 to 7 is replaced by the letter b in the reference numerals of the exemplary embodiment of FIG. 8. Relative to components denoted the same, in particular relative to components with the same reference numerals, in principle reference may be made to the drawings and/or the description of the exemplary embodiment of FIGS. 1 to 7.

FIG. 8 shows by way of example an alternative cooking-appliance system 10b which differs from the cooking-appliance system 10a shown in FIGS. 1 to 7, for example by an arrangement of an oven electronics unit 42b and/or an oven user interface 36b.

The cooking-appliance system 10b advantageously has at least one, and for example exactly one, oven 20b. The oven 20b advantageously has a muffle 40b and an oven door 74b which in an operating state advantageously closes the muffle 40b.

Advantageously, the oven 20b has at least one, and for example exactly one, oven user interface 36b. The oven user interface 36b is advantageously provided for an input and/or output of at least one oven operating parameter. In an installation position the oven user interface 36b is advantageously arranged above the muffle 40b. The oven user interface 36b is advantageously arranged on a side of the muffle 40b facing a cooktop 12b and/or a cooktop panel 14b of the cooktop 12b.

In a viewing direction 38b which is oriented parallel to a main extension plane of the cooktop panel 14b, the oven user interface 36b is advantageously arranged so as to overlap at least in some sections with the cooktop 12b. The viewing direction 38b could be oriented, for example, at least substantially parallel to a depth direction 50b. For example, in an installation position the viewing direction 38b could be oriented from a region of the cooktop 12b and/or the oven 20b facing a user, into a region of the cooktop 12b and/or the oven 20b facing away from a user.

In the present exemplary embodiment, for example, an oven electronics unit 42b of the oven 20b could be arranged in the vicinity of the oven user interface 36b and advantageously on a side facing away from a user and/or on a side of the oven user interface 36b facing the cooktop 12b. For example, in a viewing direction 38b which is oriented parallel to a main extension plane of the cooktop panel 14b, the oven electronics unit 42b could be arranged so as to overlap at least in some sections with the cooktop 12b.

For example, alternatively, in an installation position the oven electronics unit 42b could be arranged, for example, on a side of the muffle 40b facing away from the cooktop 12b and/or arranged beneath the muffle 40b, as described for example in the exemplary embodiment shown in FIGS. 1 to 7, and namely advantageously independently of an arrangement of the oven user interface 36b.

### REFERENCE NUMERALS

10 Cooking-appliance system
12 Cooktop
14 Cooktop panel
16 Extractor aperture
18 Extractor unit
20 Oven
22 Cooktop housing unit
24 Cooktop interior
26 Height extension
28 Housing unit
30 Floor
32 Height extension
34 Height extension
36 Oven user interface
38 Viewing direction
40 Muffle
42 Oven electronics unit
44 Width extension
46 Depth extension
48 Width direction
50 Depth direction
52 User interface
54 Cooktop control unit
56 Appliance unit
58 Height extension
60 Fan wheel
62 Cover unit
64 Air guiding unit
66 Exhaust air duct
68 Exhaust air line
70 Wall
74 Oven door
76 Arrangement step
78 Integration step
80 Further integration step
82 Positioning step
84 Connecting step

1-13 (canceled)

14. A cooking-appliance system, comprising:
a cooktop including a cooktop panel with an extractor aperture for suction extraction of vapors which are produced in an operating state;
an extractor unit designed for suction extraction of the vapors through the extractor aperture; and
an oven arranged beneath the cooktop in an installation position.

15. The cooking-appliance system of claim 14, constructed in the form of an induction-cooking-appliance system.

16. The cooking-appliance system of claim 14, wherein the extractor unit is arranged between the cooktop panel and the oven.

17. The cooking-appliance system of claim 14, wherein the cooktop is designed to include the extractor unit.

18. The cooking-appliance system of claim 14, wherein the cooktop includes a cooktop housing unit, which together with the cooktop panel delimits a cooktop interior, said extractor unit being arranged at least to a large part in the cooktop interior.

19. The cooking-appliance system of claim 14, wherein the cooktop has a height extension of a maximum of 300 mm.

20. The cooking-appliance system of claim 14, further comprising a housing unit which at least partially surrounds the cooktop and the oven.

21. The cooking-appliance system of claim 20, wherein the housing unit is designed for positioning on a floor.

22. The cooking-appliance system of claim 20, wherein the housing unit has a height extension of a maximum of 1000 mm.

23. The cooking-appliance system of claim 14, wherein the oven has a height extension of a maximum of 550 mm.

24. The cooking-appliance system of claim 14, wherein the oven includes an oven user interface which, in a viewing direction oriented parallel to a main extension plane of the cooktop panel, is arranged so as to overlap at least in one section with the cooktop.

25. The cooking-appliance system of claim 14, wherein the oven includes a muffle and an oven electronics unit which in an installation position is arranged beneath the muffle.

26. The cooking-appliance system of claim 14, further comprising an exhaust air duct which is arranged in terms of fluid technology downstream of the extractor unit and is designed for discharging the vapors.

27. A method for mounting a cooking-appliance system which includes a cooktop including a cooktop panel with an extractor aperture for suction extraction of vapors which are produced in an operating state, and an extractor unit designed for suction extraction of the vapors through the extractor aperture, said method comprising arranging an oven beneath the cooktop.

28. The method of claim 27, further comprising arranging the extractor unit between the cooktop panel and the oven.

29. The method of claim 27, further comprising arranging the extractor unit at least to a large part in a cooktop interior which is delimited by a cooktop housing unit together with the cooktop panel.

30. The method of claim 27, further comprising at least partially surrounding the cooktop and the oven with a housing unit.

31. The method of claim 27, further comprising arranging an oven user interface in a viewing direction which is oriented parallel to a main extension plane of the cooktop panel such as to overlap at least in one section with the cooktop.

32. The method of claim 27, further comprising arranging an oven electronics unit beneath a muffle of the oven.

33. The method of claim 27, further comprising arranging an exhaust air duct in terms of fluid technology downstream of the extractor unit for discharging the vapors.
